(19) United States
(12) Patent Application Publication
(10) Pub. No.: US 2007/0037113 A1
(43) Pub. Date: Feb. 15, 2007

(54) Dental curing light including a light integrator for providing substantially equal distribution of each emitted wavelength

(76) Inventors: Robert R. Scott, Riverton, UT (US); Dee Jessop, West Jordan, UT (US)

Correspondence Address: Rick D. Nydegger;WORKMAN NYDEGGER, 1000 Eagle Gate Tower, 60 East South Temple, Salt Lake City, UT, 84111, US

(21) Appl. No.: 11/200,988

(22) Filed: Aug. 10, 2005

(51) Int. Cl. A61C 1/00

(52) U.S. Cl. 433/29

(57) ABSTRACT

A dental curing light including a body having a housing, one or more light emitting devices disposed on or within the housing, and a light integrator configured to receive light emitted by the at least one light emitting device. The light integrator includes an outer wall defining a hollow reflective internal chamber, an input port through the wall, and an output port through the wall and spaced apart from the input port. Light is received by the light integrator through the input port and into the diffusely reflective internal chamber such that the received light is reflected in many directions and a plurality of times within the internal chamber before being emitted through the output port. Light exiting the output port of the light integrator is such that the intensity of any given wavelength emitted is substantially equally distributed across the entire footprint of emitted light.

### BACKGROUND OF THE INVENTION

1. The Field of the Invention

The present invention generally relates to the field of light curing devices. The light curing devices include an integrator for more equally distributing any given wavelength of light emitted from one or more light emitting devices (e.g., LEDs). The substantially equal distribution of a wavelength's intensity acts to reduce or eliminate “hot” and/or “cold” spots with regard to the intensity of individual wavelengths across the entire footprint of light emitted by the dental curing light.

2. The Relevant Technology

In the field of dentistry, dental cavities are often filled and/or sealed with photosensitive dental compositions that are cured by exposure to radiant energy, such as visible light. These compositions, commonly referred to as light-curable compositions, are placed within dental cavity preparations or onto dental surfaces where they are subsequently irradiated by light. The radiated light causes photosensitive components within the compositions to initiate polymerization of polymerizable components, thereby hardening the light-curable composition within the dental cavity preparation or other dental surface.

Existing light-curing devices are typically configured with a light source, such as a quartz-tungsten-halogen (QTH) bulb or an LED light source. QTH bulbs are particularly useful because they are configured to generate a broad spectrum of light that can be used to cure a broad range of products. In particular, a QTH bulb is typically configured to emit a continuous spectrum of light in a preferred range of about 350 nm to about 500 nm. Some QTH bulbs may even emit a broader spectrum of light, although filters are typically used to limit the range of emitted light to the preferred range mentioned above.

One reason it is useful for the QTH bulb to emit a broad spectrum of light is because many dental compositions cure at different wavelengths. For example, camphorquinone is a common photo-initiator used to initiate free radical polymerization that is most responsive to light having a wavelength of about 460 nm to about 470 nm. Other light-curable products, however, including many adhesives, are cured when they are irradiated by light wavelengths in the 350 nm to 410 nm range. Accordingly, QTH bulbs can be used to cure both camphorquinone initiated products as well as adhesives.

One problem with QTH bulbs, however, is that they generate a relatively high quantity of heat, making it impractical to place QTH bulbs on the portions of the light-curing devices that are inserted within the mouth of a patient. In particular, if the QTH bulbs were disposed at the tips of the light-curing devices, the heat generated by the QTH bulbs could burn or irritate the sensitive mouth tissues of the patient. Accordingly, the QTH bulbs are typically disposed remotely from the portion of the light-curing device that is inserted within a patient's mouth. The heat generated by QTH bulbs also represents wasted energy, which increases the power requirement to achieve a desired light intensity.

To channel and direct the light emitted by a QTH bulb to the desired location within a patient's mouth, light curing devices including a QTH bulb include a light guide. Although light guides are useful for their intended purposes, they add to the cost and weight of the equipment, and can add an additional level of difficulty to light-curing dental procedures.

In an attempt to overcome the aforementioned problems, some dental curing lights have been manufactured using alternative light generating sources, such as light-emitting diodes (LEDs) which are generally configured to only radiate light at a specific narrow range of wavelengths, thereby eliminating the need for special filters and generally reducing the amount of input power required to generate a desired output of radiation. LEDs are particularly suitable light sources because they generate much less heat than QTH bulbs, thereby enabling the LEDs to be placed at or nearer the tip of the curing lights and to be inserted directly within the patient's mouth. This is particularly useful for reducing or eliminating the need for light guides such as optical fiber wands.

One limitation of LEDs, however, is that they are only configured to emit a narrow spectrum of light. For example, a 460 nm LED or LED array will generally only emit light having a spectrum of 460 nm±30 nm. Accordingly, a light curing device utilizing a 460 nm LED light source will be well designed to cure camphorquinone initiated products, but will not be suitable for curing adhesives that are responsive to light in the 400 mm±30 nm range. Likewise, a light-curing device utilizing a 400 nm light source may be suitable to cure some adhesives, but will be unsuitable for curing camphorquinone initiated products.

In an attempt to overcome this limited utility, some dental curing lights have been manufactured that include multiple LEDs configured to emit light at different wavelengths. Another difficulty however, still exists with both dental curing lights employing bulbs and dental curing lights including one or more LEDs. It can be difficult to produce sufficient (and substantially even) intensities of desired wavelengths across the full footprint of light emitted by the device. In other words, there are often “hot” and “cold” areas within the footprint of light generated with respect to any given wavelength and region of the footprint.

In view of the foregoing, it would be an advantage to provide a dental curing light including at least one light source (e.g., a bulb or LED) capable of providing more even intensities of any given wavelength across the full footprint of light emitted. It would be a further advantage if at least some embodiments included a broad spectrum light source (e.g., a bulb or multiple different LEDs) so as to be capable of providing a broad spectrum of output wavelengths for curing a broad range of light activated dental compositions.

### SUMMARY OF THE INVENTION

The present invention is directed to a dental curing light including a body having a housing, one or more light emitting devices (e.g., halogen bulbs, plasma arc bulbs, or LEDs) disposed on or within the housing and configured to emit at least a first spectrum of light, and a light integrator including an outer wall, an input port through the outer wall, and an output port through the wall and spaced apart from the input port. Between the input port and the output port, the outer wall defines a hollow reflective internal chamber.

Light emitted by the at least one light emitting device is received through the input port and into the reflective internal chamber such that light is diffusely reflected internally a plurality of times before being emitted through the output port. The reflective internal chamber includes an inner surface having diffuse reflective properties. In other words, the light is reflected off the inner surface of the internal chamber in many directions. In addition, because of the spaced apart configuration the input and output ports, the light is reflected many times before exiting through the output port. The result is that light emitted from the output port is such that the intensity of any given wavelength (or wavelengths) within the emitted light is substantially equally distributed across the entire footprint of light emitted, thus reducing and/or eliminating “hot” or “cold” spots.

One embodiment includes one or more LEDs as the light emitting device. One such example includes at least two LEDs, the LEDs including at least one LED configured to emit a first spectrum of light having a first peak wavelength (e.g., UV), and at least one other LED configured to emit a second spectrum of light having a second peak wavelength (e.g., blue) different from the first peak wavelength. In such an example, the light integrator receives light emitted by the plurality of LEDs through the input port and into the reflective internal chamber. Within the reflective internal chamber, the light is diffusely reflected multiple times before exiting through the output port. The result is that the first and second peak wavelengths of light are blended together and output such that the intensities of the first and second peak wavelengths are substantially equally distributed across the entire footprint of light emitted by the dental curing light.

The light integrator may be of any desired shape (e.g., substantially spherical, substantially cylindrical, cube shaped, bar shaped, geodesical, or other shaped). One exemplary integrator is substantially spherical or cylindrical, including an input port through which light emitted by the LEDs enters, and an output port through which blended light is output. The input port may be positioned relative to the output port such that the input port is between about 70° and about 110° spaced apart from the output port. The input and output ports are preferably spaced apart between about 80° and about 100°, and more preferably spaced apart between about 85° and about 95°. In one particularly preferred example, the spaced apart relationship between the input and output ports is about 90°. Such an embodiment provides very good blending of the input light because it maximizes the number of times light is reflected before exiting through the output port.

An alternative light integrator may include one or more baffles within the reflective internal chamber of the light integrator. Such an embodiment may allow the input and output ports of the light integrator to be positioned about 180° apart, while still providing very good blending of the output light. The internal baffles increase the number of times light is reflected before exiting through the output port, resulting in good light blending. The result is substantially equal intensity of any given wavelength across the entire footprint of light emitted by the dental curing light, which reduces or eliminates “hot” and/or “cold” spots for all wavelengths within the footprint emitted.

At least the internal surface of the reflective chamber of the light integrator may be formed or coated with a material having a high reflectivity (e.g., 90% or more, 95% or more, and preferably 99% or more). A high reflectivity polytetrafluoroethylene (PTFE) is one preferred material. Other exemplary materials include barium sulfate, microporous polyester, or powder coating. Any optional internal baffles may also be coated or formed of such a material.

The dental curing light may further include a reflector positioned near the plurality of LEDs so as to redirect light into the integrator.

A related inventive method involves the steps of providing a dental curing light having a light integrator as described above, and using the dental curing light to cure a desired light-curable dental composition. Because the integrator allows the dental curing light to emit a substantially equal distribution of any (and all) given wavelengths across the entire footprint of light emitted, the possibility of an incomplete or poor quality cure is significantly reduced or eliminated.

These and other benefits, advantages and features of the present invention will become more full apparent from the following description and appended claims, or may be learned by the practice of the invention as set forth hereinafter.

### BRIEF DESCRIPTION OF THE DRAWINGS

In order that the manner in which the above recited and other benefits, advantages and features of the invention are obtained, a more particular description of the invention briefly described above will be rendered by reference to specific embodiments thereof which are illustrated in the appended drawings. Understanding that these drawings depict only typical embodiments of the invention and are not therefore to be considered limiting of its scope, the invention will be described and explained with additional specificity and detail through the use of the accompanying drawings in which:

FIG. 1A illustrates a graph charting the spectral irradiance of a Quartz Tungsten Halogen (QTH) bulb, a 380 nm LED, a 430 nm LED, and a 455 nm LED;

FIG. 1B illustrates an exemplary footprint of light emitted by an existing dental curing light wherein the intensity of any given wavelength is not substantially equally distributed across the footprint;

FIGS. 2A-2B illustrate perspective and cross sectional views of an exemplary dental curing light of the invention having an elongate wand body and that includes at least one LED and a substantially spherical light integrator disposed within the body housing;

FIG. 2C illustrates an exemplary footprint of light emitted by the exemplary dental curing light of FIGS. 2A-2B wherein the intensity of any given wavelength is substantially equally distributed across the entire footprint;

FIG. 3 illustrates a graph charting the spectral irradiance of a dental curing light of the invention including a 380 nm LED, a 460 nm LED, and a light integrator for blending both wavelengths of light;

FIG. 4 illustrates a scanning electron microscope image of a microporous PTFE material suitable for use in forming a light integrator;

FIG. 5 illustrates another exemplary dental curing light that includes one or more LED light sources and a substantially cylindrical light integrator disposed within the housing of the curing light; and

FIG. 6 illustrates another exemplary dental curing light that includes a bulb (e.g., a halogen or plasma arc bulb) light source and a light integrator disposed within the housing of the curing light.

### DETAILED DESCRIPTION OF THE PREFERRED EMBODIMENTS

I. Introduction and Definitions

A detailed description of the invention will now be provided with specific reference to Figures illustrating various exemplary embodiments. It will be appreciated that like structures will be provided with like reference designations. To help clarify the scope of the invention, certain terms will now be defined.

As used herein, the terms “light source” and “light emitting device” include any light generating device that generates light, whether a halogen or plasma arc bulb, an LED, an LED array, or other light generating source.

The terms “LED” and “LED light source,” as used herein, generally refer to one or more LEDs, one or more LED arrays, or any combination of the above that is capable of generating radiant energy. The light emitted by an LED light source includes a limited spectrum of wavelengths with a peak wavelength that corresponds with the rating of the LED light source.

The term “footprint,” as used herein, refers to the cross-sectional shape of light emitted by a dental curing light. The dimensions of the footprint will typically vary according to the distance and angle of the footprint from the point or region from which light is emitted by the dental curing light. The general shape and dimensions of a footprint can generally be identified by placing a flat object in front of a curing light and observing the area illuminated.

The term “spectrum of light” refers to light that is monochromatic or substantially monochromatic, as well as light that falls within a range of wavelengths.

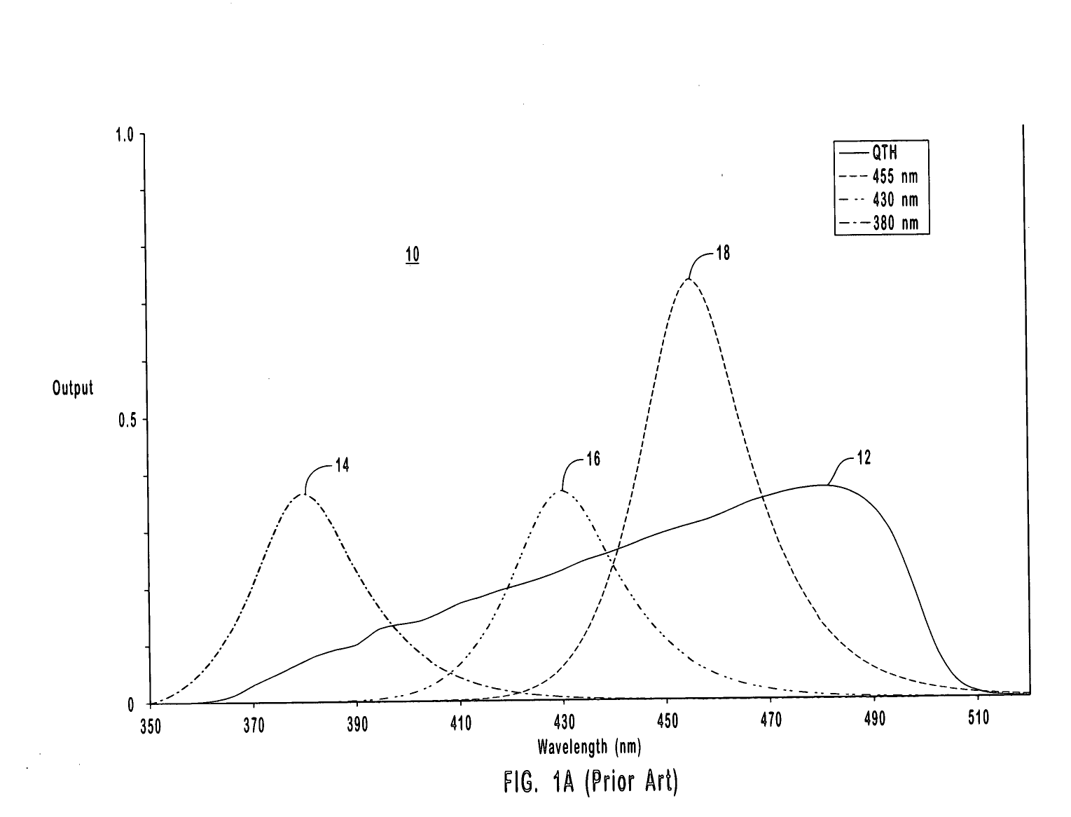

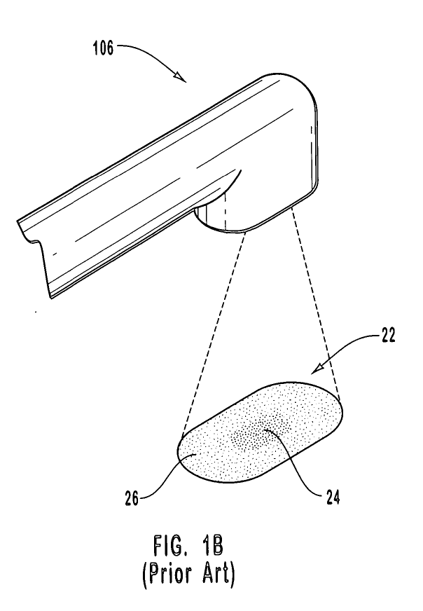

FIG. 1A illustrates a graph 10 that charts the spectral irradiance or light spectra emitted from by a quartz-tungsten-halogen (QTH) bulb, a 380 nm LED light source, a 430 nm LED light source, and a 455 nm LED light source. The values given in the y-axis are generic such that no specific representation as to the actual power output should be assumed.

As shown in FIG. 1, the QTH spectrum 12 ranges from about 360 nm to about 510 nm. The 380 nm LED spectrum 14 ranges from about 350 nm to about 430 nm, with the most intense output of light being within the range of about 360 nm to about 400 nm. The 430 nm LED spectrum 16 ranges from about 390 nm to about 480 nm, with the most intense output of light being within the range of about 410 nm to about 450 nm. The 455 nm LED spectrum ranges from about 410 nm to about 510 nm, with the most intense output of light being within the range of about 440 nm to about 470 nm.

Also shown, each of the LED spectra 14, 16 and 18 individually comprise only a portion of the spectral range of wavelengths emitted by QTH spectrum 12. Accordingly, the utility of the individual LED spectra 14, 16, and 18 is somewhat more specialized or limited than the spectral irradiance of the QTH spectrum 12. In particular, the QTH spectrum 12 can be used to cure adhesives that include photoinitiators particularly responsive to light at about 370-390 nm (i.e., UV light), as well as compositions that include camphorquinone as a photoinitiator, which is particularly responsive to light at about 430-465 nm (i.e., blue light). In contrast, none of the individual LED Spectra 14, 16 or 18 can be used to cure both camphorquinone initiated products as well as adhesives that are activated by 370-390 nm light.

In addition, existing designs of both dental curing lights employing bulbs and dental curing lights including one or more LEDs have difficulty producing substantially even intensities of desired wavelengths across the full footprint of light emitted by the curing device. In other words, there are often “hot” and “cold” areas within the footprint of light generated with respect to any given wavelength at a point or region of the footprint. FIG. 1B illustrates one example of this effect with respect to a dental curing light 20 employing one or more LEDs as light sources, although the effect is also present with dental curing lights employing a bulb as a light source. Dental curing light 20 emits a footprint of light 22. As can be seen in FIG. 1B, the region 24 near the center of footprint 22 is more heavily shaded, indicating a higher intensity of emitted light (of any given wavelength) within that region. The surrounding region 26 is shaded more lightly, indicating a lower intensity of light relative to region 24. The presence of “hot” spots (i.e., region 24) and “cold” spots (i.e., region 26) can result in uneven and/or incomplete curing of light curable compositions to be cured. Although illustrated as having a “hot” spot near the center of footprint 22, it is to be understood that “hot” and/or “cold” spots may be located anywhere within footprint 22, depending on the particular existing dental curing light. The present invention provides a dental curing light that emits a footprint where the intensity of any (and all) given wavelengths of emitted light are substantially equally distributed across the entire footprint of emitted light.

II. Exemplary Dental Curing Lights

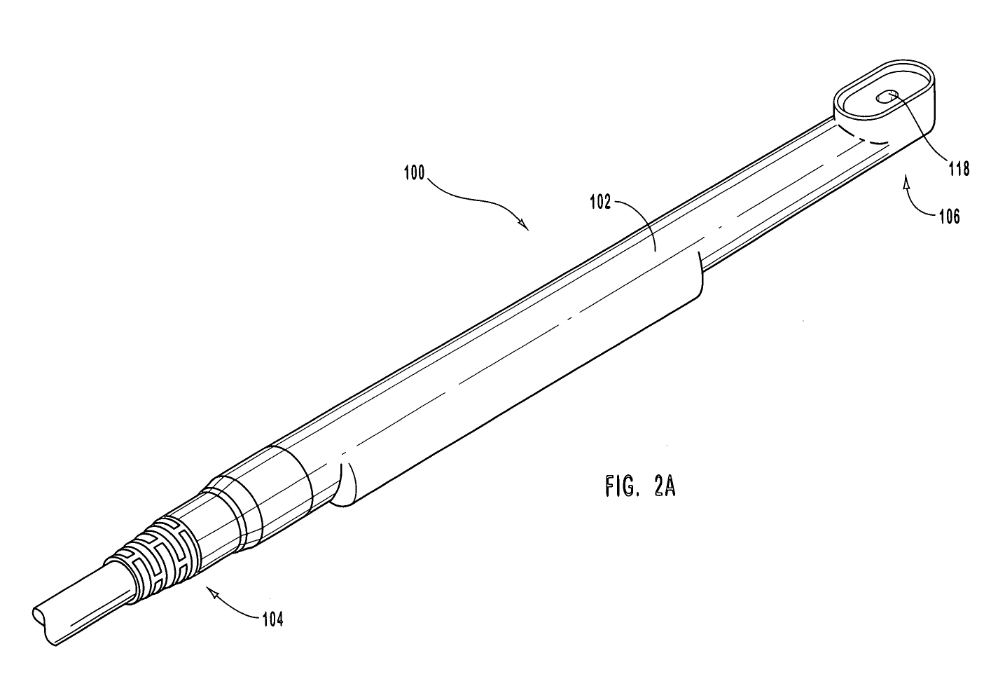

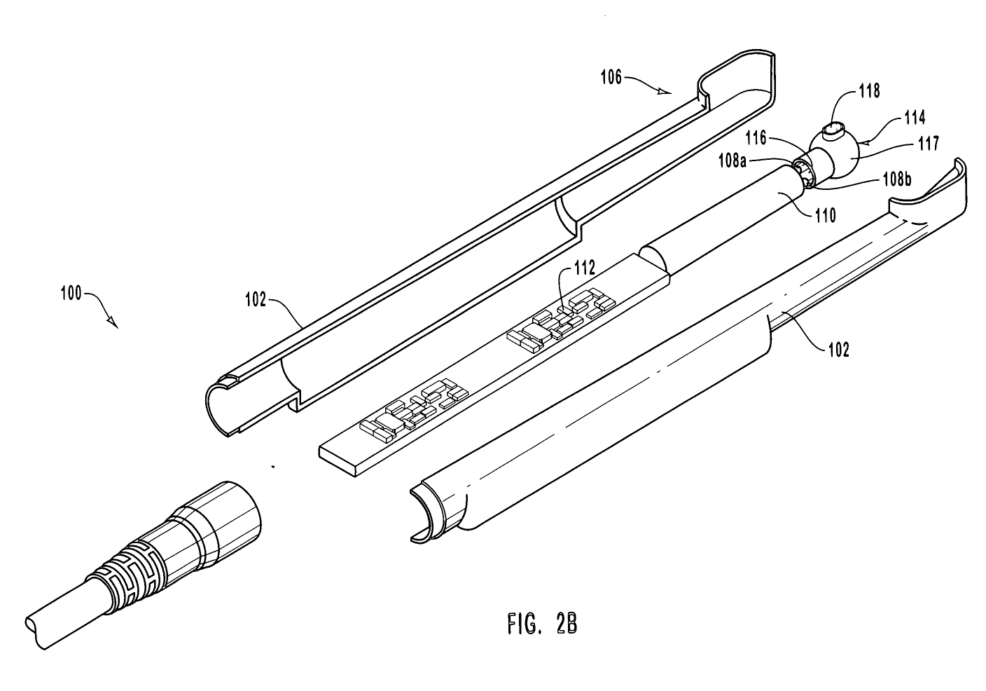

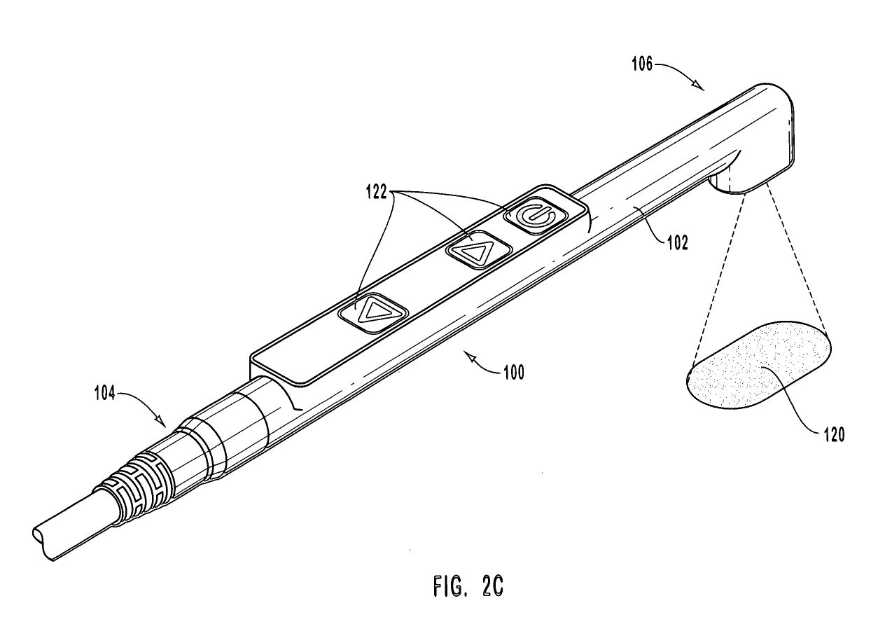

FIGS. 2A and 2B illustrate an exemplary dental curing light 100. Dental curing light 100 includes a body having a housing 102 which may be configured as an elongate wand housing having a proximal end 104 and a distal end 106. As seen in FIG. 2B, dental curing light 100 also includes two LEDs 108a and 108b disposed within housing 102. LEDs 108a and 108b may be mounted to a heat sink 110. LEDs 108a and 108b may be configured to emit the same peak wavelength or different peak wavelengths, as desired. A printed circuit board 112 may also be housed within housing 102. A substantially spherical light integrator 114 having an input port 116 is located adjacent LEDs 108a and 108b. Although illustrated as substantially spherical, the light integrator may be any desired shape (e.g., substantially spherical, substantially cylindrical, cube shaped, bar shaped, geodesical, or other shaped). Light emitted by LEDs 108a and 108b enters integrator 114 at input port 116. The light then passes into an internal chamber defined by outer wall 117. The internal chamber includes an inner surface formed from or coated with a diffusely reflective material. The light is reflected in many directions and a plurality of times before exiting as blended light through output port 118. Blended light exiting from output port 118 is such that the intensity of any given wavelength is substantially equally distributed across the entire cross sectional area of output port 118. The substantially equal distribution of the input wavelengths continues as light exits from output port 118, such that the emitted footprint of light continues to have substantially equal distribution of the various wavelengths across the entire footprint 120, as seen in FIG. 2C.

The spectrum of light emitted from output port 118 includes the same wavelength or range of wavelengths as the spectrum that entered input port 116. Light integrator 114 simply blends the wavelength or wavelengths prior to emitting the light from output port 118, resulting in substantially equal distribution of the input wavelength or wavelengths over the emitted footprint.

The dental curing light may further include a lens (not shown) connectable to the distal end 106 so as to cover output port 118, if desired. Such lenses may be desirable to change the footprint shape by focusing, diffusing or otherwise modifying the light emitted. Examples of such lenses are disclosed in U.S. patent application Ser. No. 10/423,275 filed Apr. 25, 2003 and entitled LIGHT EMITTING SYSTEMS AND KITS THAT INCLUDE A LIGHT EMITTING DEVICE AND ONE OR MORE REMOVABLE LENSES, hereby incorporated by reference with respect to its disclosure of lenses.

The dental curing light 100 may include controls disposed on the body for selectively controlling operation of LEDs 108a and 108b or other light sources within housing 102. The controls may comprise any suitable control system. One illustrated embodiment, seen in FIG. 2C, includes multiple buttons (e.g., buttons 122) disposed on elongate wand body 102. Buttons 122 or another control system may allow activation of the light source or sources on or within housing 102, as desired.

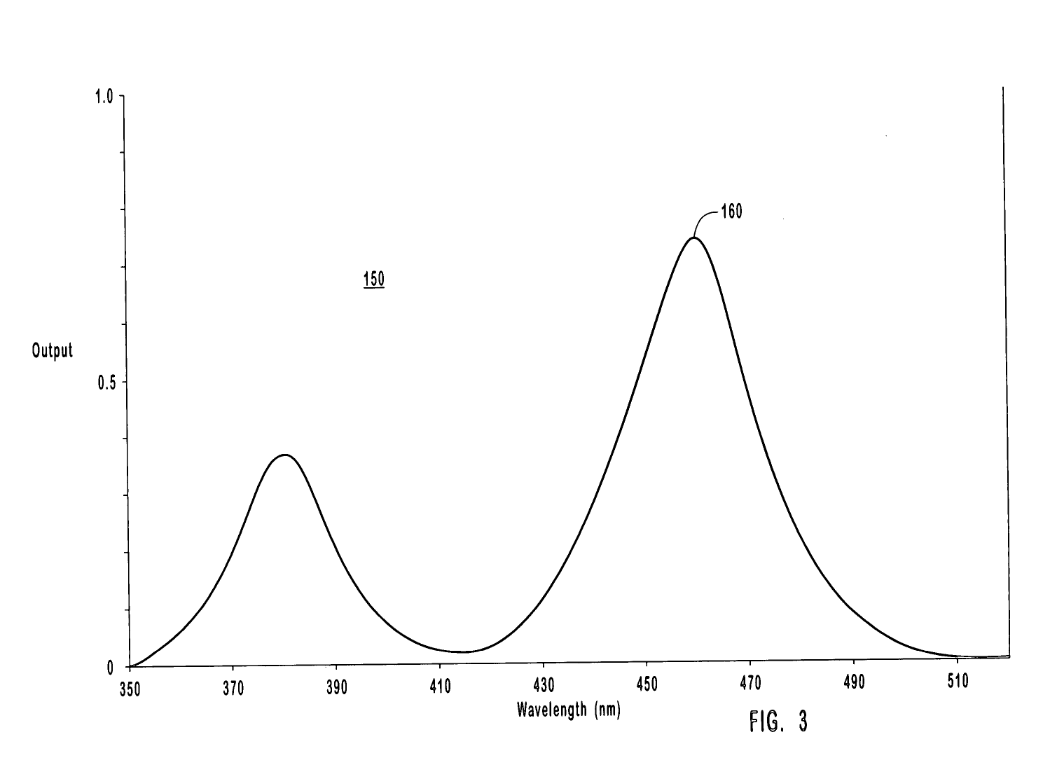

FIG. 3 illustrates a graph 150 charting the spectral irradiance of an exemplary dental curing light including two LEDs, each configured to emit a different peak wavelength. For example, in the embodiment illustrated in FIGS. 2A-2C LED 108a may be configured to emit a peak wavelength of about 380 nm, while LED 108b may be configured to emit a peak wavelength of about 460 nm. Spectral irradiance 160 includes a first peak at about 380 nm and a second peak at about 460 nm. Such a dental curing light is useful for curing both camphorquinone initiated compositions and adhesives that include a UV sensitive initiator as the spectral irradiance 160 includes both a UV component (i.e., a 380 nm peak) and a blue component (i.e., a 460 nm peak).

Although the values in the y-axis are generic, it can be seen that in some embodiments, one LED (e.g., LED 108b emitting a peak wavelength of about 460 nm) may emit at a greater intensity than another LED (e.g., LED 108a emitting a peak wavelength of about 380 nm). It is to be understood that the light integrator 114 does not necessarily even out the intensities of a first peak wavelength (e.g., 380 nm) with respect to a second peak wavelength (e.g., 460 nm). Rather, light integrator 114 evens out the intensity of each given wavelength across the footprint of light emitted such that one area of the footprint does not have a higher intensity of a given wavelength as compared to another area of the footprint. Of course, if it is desired to also even out the intensities of multiple peak wavelengths with respect to each other, the dental curing light may include LEDs with substantially equal power outputs.

Light integrator 114 may be configured such that input port 116 and output port 118 are spaced apart at any desired angle. In one embodiment, the input and output ports are spaced apart so as to be between about 70° and about 110° apart, preferably between about 80° and about 100° apart, and more preferably between about 85° and about 95° apart. In the embodiment illustrated in FIGS. 2A-2C, the input and output ports are spaced about 90° apart.

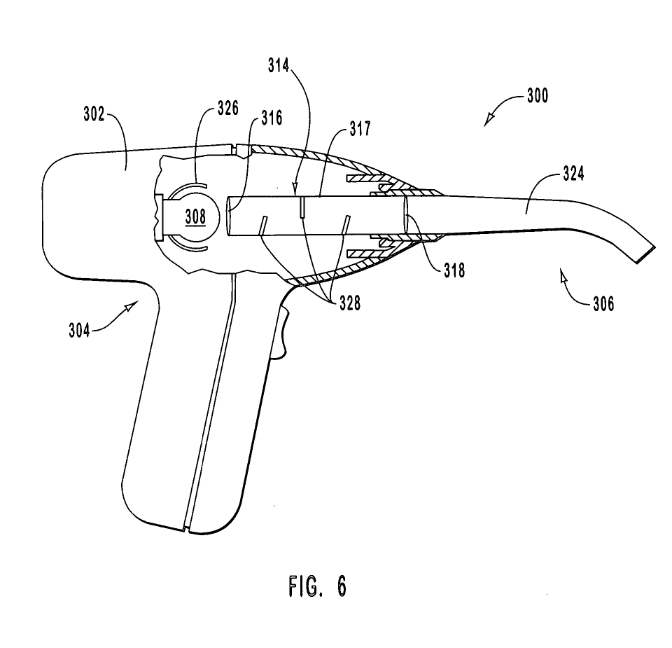

In another example, the light integrator may include one or more internal baffles. Baffles may be included with a light integrator including an input and output spaced apart at any angle, although it may be particularly preferred to include one or more internal baffles when the input and output are spaced apart at about 180° (e.g., between about 150° and about 210°). An exemplary dental curing light including an integrator with internal baffles is illustrated in FIG. 6, described in further detail below.

At least the internal chamber 117 of light integrator 114 is formed from or coated with a highly reflective material that reflects light diffusely. The material preferably has a reflectivity of at least about 90%, more preferably at least about 95%, and most preferably at least about 99%.

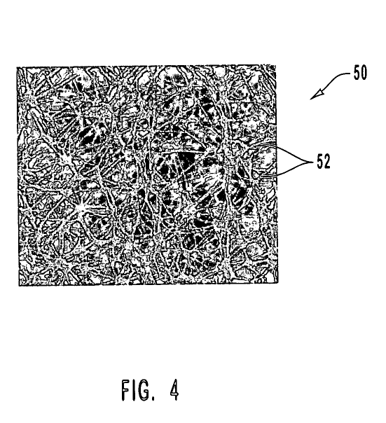

Suitable materials include, but are not limited to polytetrafluoroethylene (PTFE), microporous PTFE, granular PTFE, barium sulfate, microporous polyester, powder coating, or combinations thereof. One particularly suitable class of microporous PTFE, sold under the trade name DRP REFLECTORS, is available from W. L. Gore & Associates, Inc. located in Newark, Deleware. FIG. 4 illustrates an image 50 of a DRP REFLECTOR material magnified 5000 times. The microporous structure is formed of a plurality of PTFE fibrils 52. DRP REFLECTOR materials are one example of a class of materials having a very high diffuse reflectance (e.g., as high as 99.5%)

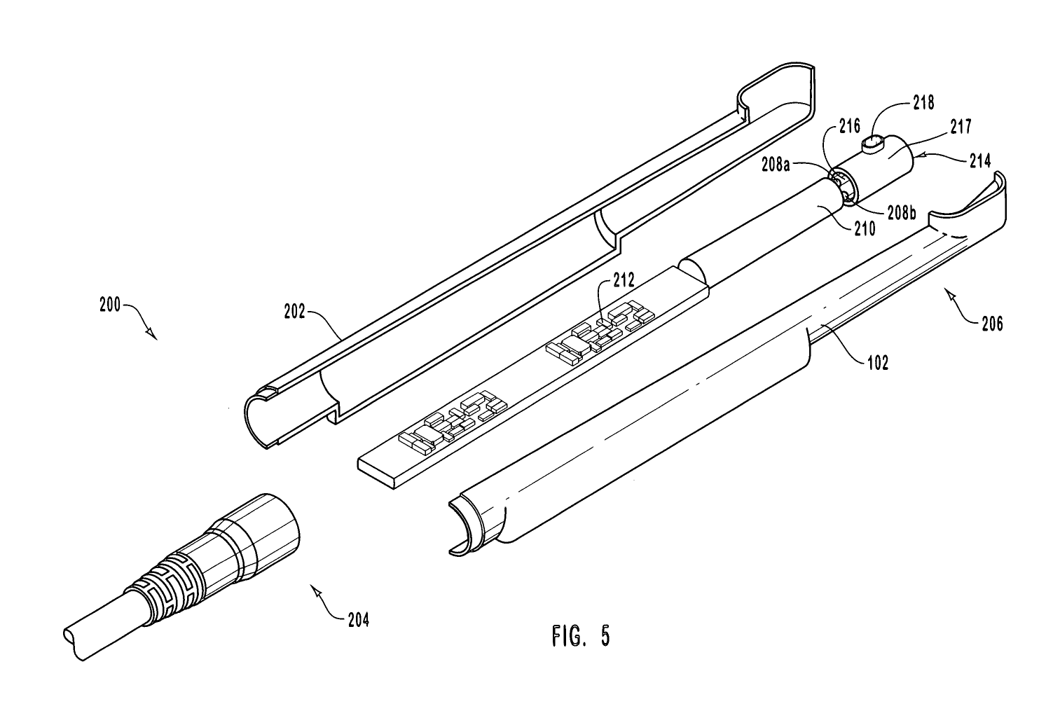

FIG. 5 illustrates an exploded view of an alternative dental curing light 200 including an elongate wand body including a housing 202 having a proximal end 204 and a distal end 206. The illustrated embodiment of dental curing light 200 includes two LEDs 208a and 208b, a heat sink 210, a printed circuit board 212, and a substantially cylindrical light integrator 214. LEDs 208a and 208b may be configured to emit light at the same peak wavelength or alternatively they may be configured to emit two different peak wavelengths, as desired. Light integrator 214 is illustrated as being located near distal end 206, although it may be located anywhere on or within housing 202. For example, light integrator 214 may be located near the mid section of housing 202, between proximal end 204 and distal end 206. Such an embodiment may include a light guide (e.g., a fiber optic light guide) for transmitting light from integrator 214 to distal end 206 of device 200.

Light integrator 214 includes an input port 216, an output port 218, and an outer wall 217 that defines a hollow reflective internal chamber. Input port 216 and output port 218 are spaced about 90° apart, although the input and output ports may be spaced apart at any desired angle. Light emitted by LEDs 108a and 108b is received through input port 216 and into the reflective internal chamber, where the light is reflected diffusely (i.e., in many directions) a plurality of times before exiting through output port 218. Because the light is reflected many times, with each reflection being in many directions, the light becomes very well blended before exiting through output port 218. The result is that the intensity of each given wavelength is substantially equally distributed across the entire footprint of light emitted by the dental curing light 200.

FIG. 6 illustrates a partial cut away side view of an alternative dental curing light 300 including a housing 302 having a proximal end 304 and a distal end 306. The illustrated embodiment of dental curing light 300 includes a bulb (e.g., halogen or plasma arc) 308 mounted within housing 302, and a cylindrical light integrator 314. Light integrator 314 includes an input port 316, an output port 318, and a reflective internal chamber defined by outer wall 317. Light emitted by bulb 308 is received through input port 316 and into the internal reflective chamber, where the light is reflected diffusely (i.e., in many directions) a plurality of times before exiting through output port 318. The result is that the intensity of each given wavelength is substantially equally distributed across the entire footprint of light emitted by dental curing light 300.

Light integrator 314 is illustrated as being located near a mid-section of curing light 300, between proximal end 304 and distal end 306. Device 300 also includes a light guide 324 for transmitting light from output port 318 of integrator 314 to a distal tip of device 300.

Device 300 may include a reflector 326 located adjacent light source 308 so as to redirect light into the input port 316 of light integrator 314. Reflector 326 may be formed of any suitable reflective material (e.g., the same material as integrator 314 or a non-diffuse reflective material). Although dental curing devices 100 and 200 described above were not illustrated as including a reflector, it is to be understood that they may or may not include a reflector, as desired.

Light integrator 314 may include an input port 316 and an output port 318 spaced 180° apart, as illustrated. In such an embodiment, it is particularly advantageous for the integrator 314 to also include one or more internal baffles 328. Baffles 328 redirect light so as to prevent the light from exiting through output port 318 before being sufficiently blended. Baffles 328 cause the light to be reflected a plurality of times and in many directions, so as to blend the light. Baffles 328 may be formed and/or coated with the same or a different high reflectivity material as the inner surface of outer wall 317. Baffles 328 may be oriented so as to be perpendicular or otherwise angled with respect to the internal surface of integrator 314, as desired. Light rays entering light integrator 314 are blended together such that the intensity of any given wavelength emitted from output port 318 is substantially equally distributed across the entire footprint of emitted light by dental curing light 300.

III. Exemplary Method of Use

According to one exemplary method, the dental curing light may be used to cure a desired light-curable dental composition. A dental curing light including a light integrator as described above is provided, and the dental curing light is used to cure a desired light-curable composition. Because the dental curing light includes a light integrator, the spectrum of light output from the dental curing light is such that each of the various wavelengths of light are emitted such that the intensity of any given wavelength is substantially equally distributed across the entire footprint of light emitted by the dental curing light, as illustrated in FIG. 2C. Because the light integrator allows the dental curing light to emit a substantially equal distribution of any (and all) given wavelengths across the entire footprint of light emitted, the possibility of an incomplete or poor quality cure is significantly reduced or eliminated.

It will be appreciated that the present claimed invention may be embodied in other specific forms without departing from its spirit or essential characteristics. The described embodiments are to be considered in all respects only as illustrative, not restrictive. The scope of the invention is, therefore, indicated by the appended claims rather than by the foregoing description. All changes that come within the meaning and range of equivalency of the claims are to be embraced within their scope.

What is claimed is:

1. A dental curing light comprising:
a body including a housing;
at least one light emitting device disposed on or within the housing, the at least one light emitting device being adapted to emit at least a first spectrum of light;
a light integrator including an outer wall, an input port through the wall, and an output port through the wall and spaced apart from the input port, the outer wall defining a hollow reflective internal chamber wherein light emitted by the at least one light emitting device is received through the input port and into the reflective internal chamber such that the received light is diffusely reflected in many directions and a plurality of times within the internal chamber before being emitted through the output port such that the intensity of any given wavelength emitted is substantially equally distributed across the entire footprint of light emitted by the dental curing light.

2. A dental curing light as recited in claim 1, wherein the at least one light emitting device comprises at least one LED adapted to emit at least a first peak wavelength.

3. A dental curing light as recited in claim 1, wherein the body comprises an elongate wand housing.

4. A dental curing light as recited in claim 1, wherein the light integrator is one of substantially spherical, substantially cylindrical, substantially cube shaped, substantially bar shaped, or substantially geodesical.

5. A dental curing light as recited in claim 1, wherein the input port of the light integrator is between about 70° and about 110° apart from the output port of the light integrator.

6. A dental curing light as recited in claim 1, wherein the input port of the light integrator is between about 80° and about 100° apart from the output port of the light integrator.

7. A dental curing light as recited in claim 1, wherein the input port of the light integrator is between about 85° and about 95° apart from the output port of the light integrator.

8. A dental curing light as recited in claim 1, wherein the integrator further comprises at least one internal baffle.

9. A dental curing light as recited in claim 8, wherein the input port of the light integrator is between about 150° and about 210° apart from the output port of the light integrator.

10. A dental curing light as recited in claim 8, wherein the input port of the light integrator is spaced about 180° apart from the output port of the light integrator.

11. A dental curing light as recited in claim 1, wherein the reflective internal chamber of the light integrator includes an inner surface formed from or coated with a material having a reflectivity of at least about 90 percent.

12. A dental curing light as recited in claim 1, wherein the reflective internal chamber of the light integrator includes an inner surface formed from or coated with a material having a reflectivity of at least about 95 percent.

13. A dental curing light as recited in claim 1, wherein the reflective internal chamber of the light integrator includes an inner surface formed from or coated with a material having a reflectivity of at least about 99 percent.

14. A dental curing light as recited in claim 1, wherein an inner surface of the outer wall of the light integrator is formed from or coated with at least one of polytetrafluoroethylene (PTFE), microporous PTFE, granular PTFE, barium sulfate, microporous polyester, powder coating, or mixtures thereof.

15. A dental curing light as recited in claim 1, further comprising a reflector positioned near the at least one light emitting device so as to redirect light into the input port of the light integrator.

16. A dental curing light comprising:
a body comprising an elongate wand housing having a proximal end and a distal end;
at least two LEDs disposed on or within the elongate wand housing, the LEDs including at least one LED configured to emit a first spectrum of light having a first peak wavelength, and at least one other LED configured to emit a second spectrum of light having a second peak wavelength different from the first peak wavelength; and
a light integrator including an outer wall, an input port through the wall, and an output port through the wall and spaced apart from the input port, the outer wall defining a hollow reflective internal chamber wherein light emitted by the at least two LEDs is received through the input port and into the reflective internal chamber such that the received light is diffusely reflected in many directions and a plurality of times within the internal chamber before being emitted through the output port such that the first and second peak wavelengths of light are blended and output such that the intensities of each of the first and second peak wavelengths are substantially equally distributed across the entire footprint of light emitted by the dental curing light.

17. A dental curing light as recited in claim 16, wherein at least one LED is configured to emit a first spectrum of light having a first peak wavelength within a UV range.

18. A dental curing light as recited in claim 16, wherein at least one LED is configured to emit a first spectrum of light having a first peak wavelength within a blue range.

19. A method comprising:
providing a dental curing light comprising:
a body including a housing;
at least one light emitting device disposed on or within the housing, the at least one light emitting device being adapted to emit at least a first spectrum of light;
a light integrator including an outer wall, an input port through the wall, and an output port through the wall and spaced apart from the input port, the outer wall defining a hollow reflective internal chamber wherein light emitted by the at least one light emitting device is received through the input port and into the reflective internal chamber such that the received light is diffusely reflected in many directions and a plurality of times within the internal chamber before being emitted through the output port such that the intensity of any given wavelength emitted is substantially equally distributed across the entire footprint of light emitted by the dental curing light; and
using the dental curing light to cure a desired light curable composition.

20. A method as recited in claim 19, wherein the dental curing light is used to cure a camphorquinone initiated light curable composition.

21. A method as recited in claim 19, wherein the dental curing light is used to cure a UV initiated light curable composition.
